(19) United States
(12) Patent Application Publication
(10) Pub. No.: US 2003/0221364 A1
(43) Pub. Date: Dec. 4, 2003

(54) Support system for trees and the like

(76) Inventor: Raymond Anthony Mello, Elverta, CA (US)

Correspondence Address: RAYMOND ANTHONY MELLO, 9500 BASELINE ROAD, ELVERTA, CA, 95626, US

(21) Appl. No.: 10/452,023

(22) Filed: May 30, 2003

Related U.S. Application Data
(60) Provisional application No. 60/384,525, filed on May 30, 2002.

(51) Int. Cl. A01G 13/02

(52) U.S. Cl. 47/32.7

(57) ABSTRACT

Support system for trees and the like having a base adapted to be placed in the ground around the roots of a tree for directing the roots to grow in a downward direction, a socket on the base for supporting a post in a fixed position, a post which is mounted in socket and extends above the ground, a guide which is engagable between the post and a portion of the tree above the ground to train the tree for growth in a predetermined manner, and an irrigation system on the base for delivering water to the roots beneath the surface of the ground.

### RELATED APPLICATION

Priority based upon Provisional Application No. 60/384,525, filed May 30, 2002, is claimed.

### BACKGROUND OF THE INVENTION

1. Field of Invention

This invention pertains generally to landscaping and, more particularly, to the planting and support of young trees, shrubs, flora and other vegetation and plant life, all of which are referred to hereinafter collectively as trees.

2. Related Art

Landscaping commonly involves the introduction of new elements (eg., trees, rocks, water effects, and the like) into locations where they are not originally found.

Transplanting mature, fully-grown trees is generally not feasible due to the high costs of the trees themselves and of excavating enough ground to accommodate the fully developed root structures of such trees. Consequently, the trees most commonly used in landscaping are immature trees with shallow, less developed root structures.

Unless supported, transplanted trees may not grow straight and vertical because of the side loading forces exerted on them by the wind. Unlike the deep, broad root structures of mature trees, the less developed root structures of immature, transplanted trees generally do not provide the horizontal structural stability required to keep them vertically erect when subjected to prolonged or powerful winds. The problem often is compounded by attempts to save money by digging relatively shallow holes for new trees, although simply planting them in deeper holes does not always avoid the problem either.

Heretofore, the most common way of trying to stabilize newly planted trees has been the use of posts or stakes driven in the ground near the trunks of the trees, with ties attaching the trees to the posts at one or more points long the trunks. The posts are most commonly made of wood or metal, and the ties are typically materials such as natural fiber strings (e.g., cotton string or rope), synthetic strings, rubber, wires or chains.

Although relatively inexpensive, the use of such posts or stakes has a number of limitations and disadvantages.

In theory, the force extended on the tree by the winds will be reduced by shifting a portion of it to the posts. However, it does not always work out that way. While the posts do indeed bear some of the wind-generated force exerted on the trunk, but the trunk is also forced to bear a portion of the force that is exerted on the posts. These counterforces significantly diminish the effectiveness of the posts and may even cancel it entirely.

The counterforces can be reduced by using fewer posts, but that would also decrease the stabilization provided to the trees. The counterforces can also be reduced by loosening the ties between the posts and the trees, but that limits the ability of the posts to stabilize the trees.

Another problem with posts is that when the soil into which they are driven is uncompacted backfill, which is common around newly planted trees, it is incapable of holding the posts securely. That makes it necessary to drive the posts deeper into the ground, which is more costly and can be hazardous, particularly in the case of metal posts. Moreover, as the soil resettles, the posts may shift position and actually pull the trees away from vertical.

Also, posts made of wood and metal generally have a relatively uniform rigidity along their length and are not capable of bending more toward the top than toward the bottom to accommodate the natural movements of a tree in variable climate conditions such as blowing winds.

Wooden posts or stakes also tend to warp and bend over time, which further compromises their effectiveness as stabilizing devices.

Sometimes, it is necessary or desirable to adjust the aboveground height of the posts or stakes after they have been installed so that they will be tall enough to provide supports yet not so tall as to impede the growth of the upper branches the tree. Cutting stakes after they have been installed can be difficult, particularly with metal stakes, and it can also cause the stakes to shift, further impairing their effectiveness as stabilizing devices.

Another problem with posts or stakes driven into the ground is that the developing root systems of the transplanted bees often grow around the stakes, making it difficult to remove them from the ground after they have performed their function.

The ties heretofore used for attaching trees to posts also have certain limitations and disadvantages. They tend to rub against and scar the trunks of the trees, and they can also impede the growth or development of the trees by choking them or otherwise limiting their natural free movement. In addition, they may stretch, slip or loosen, or they may break or otherwise require maintenance and/or replacement.

Heretofore, there have also been some subterranean attempts to stabilize newly planted trees by forcing their developing root systems to grow deep into the ground, rather than spreading laterally and forming a shallow root system.

In one such approach, a deep root barrier is installed in the ground around the root structure of a newly planted tree. The barrier is typical in the form of a truncated cone or pyramid, with openings at the top and bottom for the trunk and roots.

While deep root barriers have proved to be effective in forcing root systems to develop properly, they provide no aboveground support to foster straight, vertical growth of the trees. The deep root structure may prevent the tree from being entirely uprooted, but it does nothing to ensure that the tree will be straight and vertical. Also, the deep root barriers heretofore provided have not had any type of irrigation system for the trees.

In another such approach, a plastic retaining wall is installed in the ground around the root system of a tree. The retaining wall typically has a plurality of vertical extending, interlocking, flat plastic panels which are installed around the perimeter of the hole before the tree is placed in it. Unfortunately, the plastic walls often fail by being broken or pried apart by the immense forces of the growing root systems, allowing the roots to spread laterally, rather than forcing them to grow down, deeper into the ground. These retaining walls also tail to provide any structural support or stay to the aboveground portions of the trees.

### OBJECTS AND SUMMARY OF THE INVENTION

It is, in general, an object of the Invention to provide a new and unproved support system for trees and the like.

Another object of the invention is to provide a system of the above character which provides support both aboveground and subterranean.

These and other objects are achieved in accordance with the invention by providing a support system for trees and the like having a base adapted to be placed in the ground around the roots of a tree for directing the roots to grow in a downward direction, a socket on the base for supporting a post in a fixed position, a post which is mounted in the socket and extends above the ground, a guide which is engagable between the post and a portion of the tree above the ground to train the tree for growth in a predetermined manner, and an irrigation system on the base for delivering water to the roots beneath the surface of the ground.

### BRIEF DESCRIPTION OF THE DRAWINGS

FIG. 1 is an isometric view of one embodiment of a support system for trees and the like in accordance with the invention.

FIG. 2 is an exploded elevational view of the embodiment of FIG. 1, with the irrigation system removed for convenience of illustration.

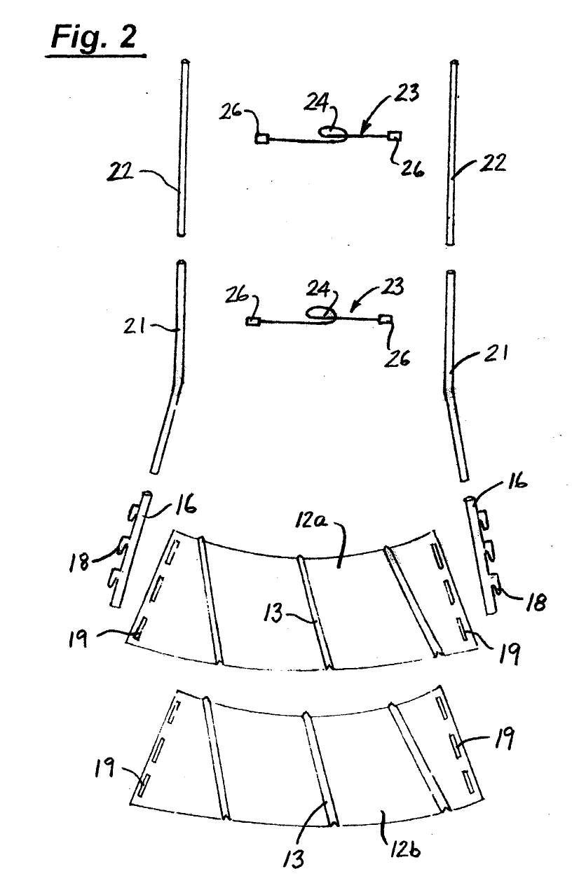

FIG. 3 is an isometric view, partly broken away, of another embodiment of a support system incorporating the invention in conjunction with a tree.

FIG. 4 is an exploded isometric view of the embodiment of FIG. 3.

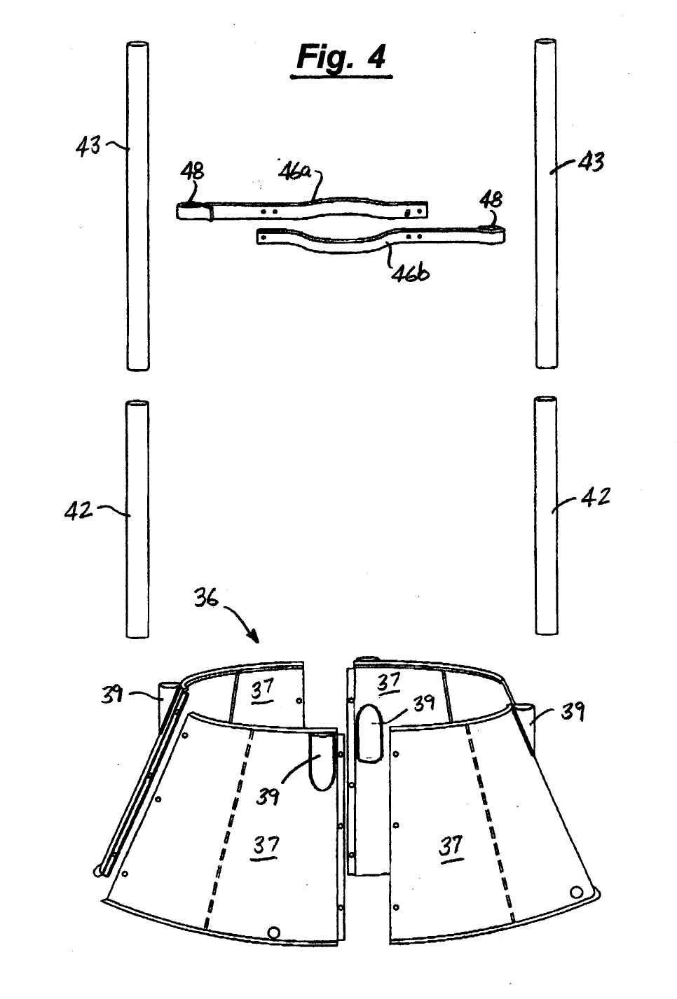

### DETAILED DESCRIPTION

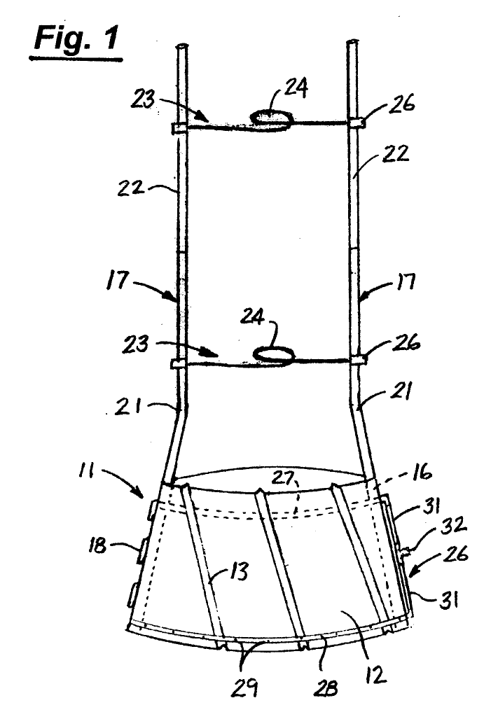

As illustrated in FIG. 1, the support system includes a base 11 which has a downwardly and outwardly inclined side wall 12 that is adapted to be placed in the ground around the root structure of a tree. The top of the base is open to accommodate the trunk of the tree, and the bottom is open so that the developing root system can grow in a downward direction. As in a conventional deep root barrier, the solid side wall prevents the roots from growing sideways and developing improperly, i.e. broad and shallow.

The side wall is fabricated of a material which is rigid enough to direct the growing roots in a downward direction, yet flexible enough to permit the wall to be formed to the desired shape. Suitable materials include a metal such as aluminum, plastics, fiberglass, or composite materials. If desired, it can also be made of a biodegradable material which would limit the lifetime and environmental impact of the system.

The side wall has a plurality of obliquely extending ribs 13 which stabilize it and make it more rigid and better able to deflect the roots in the desired downward direction.

In the embodiment illustrated, the she wall is formed in two sections 12a, 12b which are connected together to form a unitary structure. If desired, a greater or lesser number of sections can be employed to make a base of larger or smaller diameter.

Although the base is illustrated as being circular and as having a frustoconical side wall, it can have other shapes if desired, e.g., square, a truncated pyramid, a free form or a contour which follows that of the root structure.

Regardless of the contour, having the base wider at the bottom than at the top makes it significantly more stable than one with a vertical side wall would be. As the hole in which the base is place is backfilled, the weight of the soil above the inclined side wall effectively bears down on all sides of the base, anchoring it securely in place so that it is not likely to be dislodged by the developing root system.

The base can be left in the ground for the life of the tree, or removed and replaced, if desired.

A plurality of guide tubes 16 are attached to the side wall of the base to form sockets for holding posts 17 in an upright, vertical position above the ground. In the embodiment illustrated, the tubes have hooks 18 which are received in received in interlocking relationship in aligned openings 19 in overlapping end portions of the wall sections. Thus, the hooks connect the wall sections together as well as affixing the guide tubes to them. The tubes are open at the bottom, so that water can run out of them.

As a tree gets older and the posts are no longer needed, they can be removed, and the empty tubes used for other purposes such as fertilizer delivery vessels or access openings for direct deep root watering. Since the tubes run the full inclined height of the side wall, fertilizer pellets introduced into the tubes near the top of the wall will drop directly to the bottom, closer to the root structure. Similarly, water introduced into the tubes is directed to the bottom of the wall, eliminating the problem of runoff and ensuring that the water is channeled directly to the roots.

If fertilization and/or additional deep root watering is required before the tree is mature enough to stand on its own, the posts can be removed temporarily to permit fertilizer and/or water to be introduced through the guide tubes. Similarly, any tubes which are not supporting posts can be used at any time for introducing fertilizer and/or water.

In the embodiment illustrated, each of the posts consists of a relatively rigid lower section or guide post 21 which is received in the guide tube or socket, and a relatively flexible upper section or training pole 22 which extends in an upward direction from the lower section. The guide post is bent at an angle corresponding to the inclination of side wall 12 so that when it is placed in the guide tube and oriented property, the upper portion of that section and the entire training pole will be upright and vertical.

The posts can be fabricated of a variety of materials such as metal, plastic or PVC tubing. In one presently preferred embodiment, the relatively rigid guide post is metal tubing, and the relatively flexible training pole is PVC tubing. The support provided by this combination has been found to be extremely effective for a developing tree.

Posts or poles which provide varying degrees of support along their length help to relieve stress and pressure on the upper caliper of a tree during extremely windy conditions. With greater flexibility at the top, the risk of the tree's snapping and breaking above the training supports is reduced. Stated differently, the training poles provide the necessary “give” that a developing tree requires at its higher points.

The guide posts and training poles are much simpler and faster to install than conventional wood and metal stakes, and they can be positioned more accurately and held more securely. Instead of having to be pounded into the ground, the guide posts are simply slid into the prefabricated guide tubes, and the training poles are slid into the guide poles and clamped in place.

Alternatively, if varying flexibility is not required, the posts can be single lengths of suitable material such as wood, metal or plastic.

A plurality of training supports or guides 23 are mounted on the posts for engagement with the trunk to train tree for growth in an upright, vertical manner. The guides are relatively rigid and have a soft, non-abrasive outer layer or coating to protect the tree. They are formed with a portion 24 which loosely encircles the tree and are secured to the poles by clamps 26. In the embodiment illustrated, the encircling portion is a loop having a diameter several inches greater than the trunk it encircles, with the center of the loop being positioned equidistant from the two poles to which the guide is attached.

The clamps permit the guides to be attached, removed and reattached to the posts at any height, so that the position of the guides is entirely adjustable. In addition, the use of more than one guide ensures that the tree will grow straight as well as vertical.

Having the guides loosely encircling the trunk permits a moderate amount of trunk movement, which has been found to promote stronger structural development of the trunk. In addition, it limits such movement within prescribed bounds, thereby ensuring that the trunk is allowed only a small degree of deviation from a perfectly vertical orientation.

A drip irrigation system 26 is mounted on the base to provide irrigation for the tree. This system includes drip lines 27, 28 which extend along the upper and lower edge portions of side wall 12, with emitters 29 spaced evenly along them. Drip line 27 extends along the interior side of the upper edge portion to supply water to shallow roots, and line 28 extends along the exterior side of the lower edge portion to promote downward and outward growth of the deeper roots. Water is supplied to the drip lines through feed lines 31 and a connector 32.

In use, a hole is dug deep enough and wide enough to accommodate the root structure of the tree, and the base is placed in the hole with the upper edge of side wall 12 roughly flush with the surface of the ground. A water fine is connected to the irrigation system, and the tree is placed in the hole inside the base. The poles are inserted into their sockets, and the hole is backfilled, with the poles extending vertically above the ground. Guides 23 are then wrapped loosely around the trunk and clamped to the poles.

Alternatively, if desired, the tree can be placed in the hole first and the base assembled and the irrigation system installed around it. However, it is usually easier to position the base before the tree.

As the tree grows, the guides can be adjusted in height and replaced with guides of larger diameter, if necessary. When the posts are no longer needed, they can be removed, and fertilizer and/or water can thereafter be introduced through the tubes in which they were mounted. When no longer needed, the base can be left in the ground or removed, as desired.

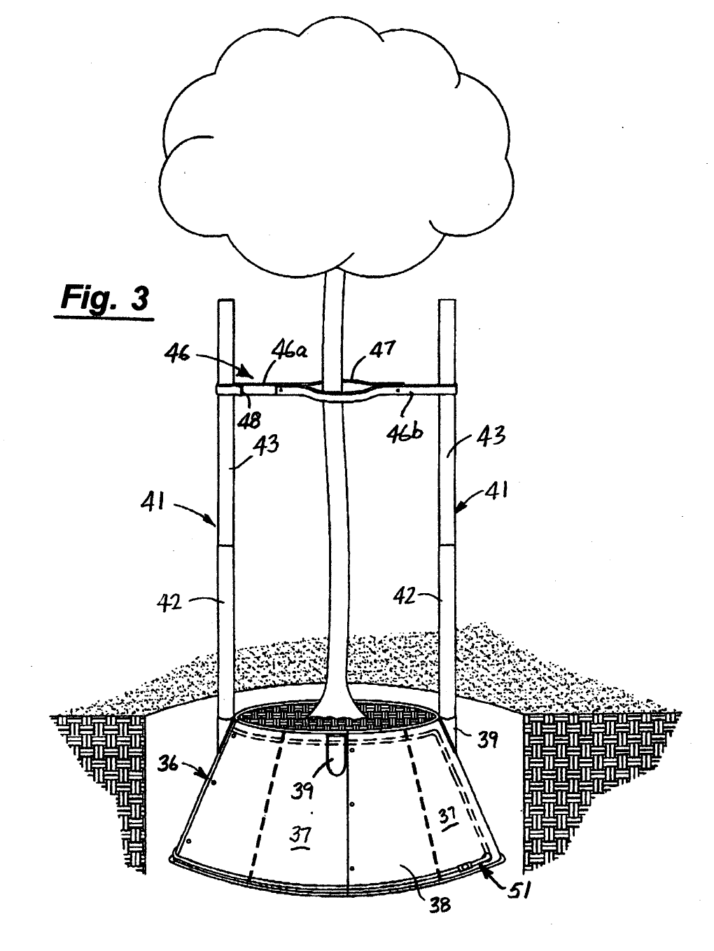

In the embodiment of FIG. 3, base 36 is formed in four sections 37 which are bolted together to form a downwardly and outwardly inclined side wall 38. As in the embodiment of FIG. 1, a greater or lesser number of sections can be employed to provide a base of greater or lesser diameter.

Each of the wall sections includes a vertically extending tube 39 which passes through the wall and forms a socket for receiving a support post 41. In the preferred embodiment, the tubes are formed integrally with the wall sections.

As in the embodiment of FIG. 1, each of the support posts has a relative rigid lower section or guide post 42 and a relatively flexible upper section or training pole 43.

Tree clips 46 mounted between the posts serve as guides for training the tree to grow straight and vertical. Each of the clips has two identical sections 46a, 46b which are bolted together to form a ring 47 that loosely encircles the trunk of the tree. The outer end portions of the two sections are bent to form hooks 48 which snap onto the poles and hold the clips in place. The clips can be mounted on the poles at any desired height, and although only one clip is shown in the drawings, one or more additional clips can be employed at other heights, if desired. The clips have a soft protect coating or layer to prevent damage to the trunk of the tree.

A drip irrigation system 51 similar to system 26 is mounted on base 36 for deep root watering and to promote the downward and outward development of the root system.

Operation and use of the embodiment of FIG. 3 is similar to that described above. However, the tree clips are even easier to install, position and/or replace because of the manner in which they simply snap onto the poles and bolt together.

The invention has a number of important features and advantages. It provides a complete planting and support system for trees and the like. It is quickly and easily assembled from component parts, and installation is very easy, inexpensive, and safe.

Since the base fits relatively closely around the root structure, the amount of soil which must be removed is much less than what is typically required to be excavated in most plantings with root barriers. In other words, landscapers do not need to excavate extra ground around the root system in order to install the base.

Installation of the guide posts is very fast, much faster than wood or metal stakes. Whereas wood or metal stakes must be pounded into the ground, which is time consuming and laborious, the installation of these guide posts only requires that they be inserted into the pre-fitted guide tubes, which requires very little effort. In addition, pounding stakes into the ground disturbs the adjacent soils which often makes it difficult for the wood or metal stakes to maintain a secure vertical upright position.

Installation of the guide posts is also much less dangerous than driving stakes into the ground, which can, and often does, lead to physical injury. With the invention, the posts need only be slipped into the guide tubes, which essentially eliminates the possibility of physical injury, and therefore significantly reduces a contractor's potential liability from employee injury.

Installation of the training supports or guides is also extremely easy, requiring only that they be attached to the guide posts by clamps, screws, or other means. This is much easier and faster than tying rubber or wire ties around the trunk of the tree.

Being mounted in fixed sockets, the guide posts and training poles have a uniform appearance whereas with wood or metal stakes driven into the ground, it is difficult to ensure that all stakes are vertical and of the same height.

Once the tree has developed sufficiently, the guide posts, training poles and supports may be quickly and easily removed and reused again.

The system requires little or no maintenance, the self-contained irrigation system ensures proper watering of the trees, and the cost of the complete system, including labor, is lower than that of other systems.

The components of the system are stackable, reusable, or biodegradable, which reduces stocking and shipping costs, and significantly decreases installation and maintenance costs as well as environmental impact.

The guide posts are removable and reusable from project to project and from tree to tree, which reduces the total cost of landscaping projects and helps to minimize the environmental impact of the system.

In addition, the removability of the posts greatly simplifies other landscaping tasks, such as mowing and other landscape maintenance or repair around the tree. It also allows the guide tubes to be used as direct channels to the root system, enabling the immediate, simplified, and precise delivery of fertilizer and/or water to the root structure of a developing tree.

Having an irrigation system as an integral part of the system also helps to reduce installation costs by the labor required to install a separate irrigation system for the tree.

The system effectively directs a developing root structure in the proper direction (down) and prohibits the roots from growing horizontally unless and until they have reached a sufficient depth to sustain the tree. In this way, the system forces the developing root structure to grow properly, which creates much greater structural stability for the tree and minimizes the risk of its being uprooted. It also prevents trees from having shallow roots which can cause sidewalks, driveways and other hardscapes to crack and break, which could result in injury and liability to property owners.

With the guide tubes attached to the side wall of the base, the effective functionality of the deep root barrier is combined with a simplified method of anchoring guide posts.

The height of the training supports or guides is easily and fully adjustable, enabling the installer to determine precisely the trunk height or heights at which support will be given. It also ensures that the guides will not impede the growth of the head or branches of the tree.

The possibility of using multiple training supports or guides allows additional supports to be installed for the tree as it continues to grow. The soft, non-abrasive protective coating on the training supports protects the tree trunk from damage that can occur when a support comes into contact with the trunk.

With the training supports loosely encircling the tree trunk, the tree is permitted a moderate degree of movement, which is necessary for proper strengthening of the tree, yet limited within a predefined space, ensuring that the tree develops straight and vertically. This is a significant improvement over previous systems with stakes and ties, which almost always bend or pull a tree away from a vertical orientation.

The multi-piece construction of the base allows it to be installed even after a young tree or plant has been transplanted. It can likewise be removed from the ground without disturbing the tree.

The deep root system produced by the invention ensures a strong stable tree which is not likely to fall over like a tree which does not have roots that are deep enough to sustain or support itself. That avoids the expense of having to have the tree removed so that it will not endanger lives or property. The straight, upright, properly developed trees produced by the invention can add value to the property on which they are located.

By comprehensively addressing both the aboveground and subterranean issues and challenges inherent in planting young, developing trees, this system succeeds in fostering the growth of strong, straight trees, whereas others have failed by creating bent, leaning, and/or uprooted trees.

It is apparent from the foregoing that a new and improved support system for trees and the like has been provided. While only certain presently preferred embodiments have been in detail, as will be apparent to those familiar with the art, certain changes and rotations can be made without departing from the scope of the invention as defined by the following claims.

1. A support system for trees and the like, comprising: a base adapted to be placed in the ground around the roots of a tree for directing the roots to grow in a downward direction, a guide tube on the base for supporting a post in a flexed position, a post which is mounted in the guide tube and extends above the ground, and a guide which is engagable between the post and a portion of the tree above the ground to train the tree for growth in a predetermined manner.

2. The support system of claim 1 wherein the base has a downwardly and outwardly inclined side wall which encircles the tree.

3. The support system of claim 1 wherein the base is formed in a plurality of sections, and different numbers of the sections can be connected together to form bases of different lateral dimension.

4. The support system of claim 1 wherein the guide tube is open at the bottom and can also be used as a channel for delivering fertilizer and water to the roots of the tree.

5. The support system of claim 1 wherein the post has different flexibilities at different points along its length.

6. The support system of claim 1 wherein the post has a relatively rigid lower section and a relatively flexible upper section.

7. The support system of claim 1 wherein the guide is attached to the post in a manner permitting the guide to be utilized in different positions along the length of the post.

8. The support system of claim 1 wherein the guide loosely encircles the trunk of the tree.

9. The support system of claim 1 including an irrigation system mounted on the base for delivering water to the roots beneath the surface of the ground.

10. The support system of claim 9 wherein the irrigation system includes a plurality of drip emitters spaced along upper and lower edge portions of the base.

11. A support system for trees and the like, comprising: a base having a downwardly and outwardly inclined side wall adapted to be placed in the ground around the roots of a tree, a plurality of vertically extending sockets spaced peripherally of the base for supporting posts in fixed, upright positions, a plurality of posts which are mounted in the sockets and extend above the ground in a vertical direction, and a plurality of guides which are engagable between the posts and the trunk to train the trunk for growth In a straight vertical manner.

12. The support system of claim 11 wherein the base is formed in a plurality of sections, with each section having one of the sockets affixed to it.

13. The support system of claim 11 wherein the sockets are formed by guide tubes which are open at the bottom and can also be used as channels for delivering fertilizer and water to the roots of the tree.

14. The support system of claim 11 wherein each of the posts has a relatively rigid lower section and a relatively flexible upper section.

15. The support system of claim 11 wherein each of the guides is attached to two of the posts and loosely encircles the trunk at a different height.

16. The support system of claim 11 including an irrigation system mounted on the base for delivering water to the roots beneath the surface of the ground.

17. The support system of claim 16 wherein the irrigation system includes a plurality of drip emitters spaced along upper and lower edge portions of the side wall.

18. A support system for trees and the like, comprising: a base having a plurality of sections which are connected together to form a downwardly and outwardly inclined side wall adapted to be paced in the ground around the roots of a tree, a vertically extending socket affixed to each section of the side wall, a post mounted in each of the sockets extending above the ground in a vertical direction, at least one guide which is engagable between the posts and the tree to train the trunk for growth in a predetermined manner, and an irrigation system on the base for delivering water to the roots beneath the surface of the ground.

19. The support system of claim 18 wherein the sections are curved, and the side wall is conical.

20. The support system of claim 18 wherein the sections are generally planar, and the side wall is pyramidal.

21. The support system of claim 18 wherein the sockets am formed integrally with the wall sections.

22. The support system of claim 18 wherein the sockets are formed by guide tubes which are open at the bottom and can also be used as channels for delivering fertilizer and water to the roots of the tree.

23. The support system of claim 18 wherein each of the post has a relatively rigid lower section and a relatively flexible upper section.

24. The support system of claim 18 wherein each of the guides is attached to two of the posts and loosely encircles the trunk at a different height.

25. The support system of claim 18 including an irrigation system mounted on the base for delivering water to the roots beneath the surface of the ground.

26. The support system of claim 25 wherein the irrigation system includes a plurality of dripper emitters spaced along upper and lower edge portions of the side wall.

27. A support system for trees and the like, comprising: a base having a downwardly and outwardly inclined side wall adapted to be placed in the ground around the roots of a tree, a plurality of vertically extending sockets spaced peripherally of the side wall for receiving support posts and holding the posts in fixed, upright positions near the trunk of the tree, and a plurality of irrigators spaced along the upper inner edge and the lower outer edge of the side wall for delivering water to the roots beneath the surface of the ground.

28. The support system of claim 27 wherein the side wall is formed in a plurality of sections which can be connected together in different numbers to form bases of different lateral dimension.

29. The support system of claim 27 wherein the side wall of the base is frustoconical.

30. The support system of claim 27 wherein the side wall of the base has a plurality of relatively flat sections.

31. The support system of claim 27 wherein the sockets are formed by guide tubes which are open at the bottom and can also be used as channels for delivering fertilizer and water to the roots of the tree.
